(19) United States
(12) Patent Application Publication
(10) Pub. No.: US 2018/0066764 A1
(43) Pub. Date: Mar. 8, 2018

(54) FAST ACTING VALVE

(71) Applicants: ROGER M. DUFFIN, PAUL, ID (US); DON D. DUFFIN, PAUL, ID (US)

(72) Inventors: ROGER M. DUFFIN, PAUL, ID (US); DON D. DUFFIN, PAUL, ID (US)

(21) Appl. No.: 15/792,558

(22) Filed: Oct. 24, 2017

Related U.S. Application Data
(60) Provisional application No. 62/378,747, filed on Aug. 24, 2016.

(51) Int. Cl. F16K 31/06

(52) U.S. Cl. CPC F16K 31/0672; F16K 31/0675; F16K 31/0655

(57) ABSTRACT

A fast-acting valve for the control of fluid. The valve has two chambers, each with its own diaphragm. The valve, when filled with fluid will have equal pressure against both diaphragms which will allow little resistance for a poppet to open and close in >0.1 seconds. The poppet is attached to a rod which moves from a first position to a second position using low electric force or hydraulic power in combination with a biasing mechanism allowing for rapid toggling between two positions.

### PRIORITY/CROSS-REFERENCE TO RELATED APPLICATION

This application claims the benefit of U.S. Provisional Application No. 62/378,747, filed Aug. 24, 2016, the disclosure of which is incorporated by reference.

### TECHNICAL FIELD

The presently disclosed and claimed inventive concept(s) generally relates to an apparatus for a valve, and more particularly to a fast acting valve for sprinkler and irrigation purposes.

### BACKGROUND

Valves are used for a variety of purposes to control the flow of fluid. A valve is an apparatus that directs and controls fluids, gasses, or fluidized solids. Most valves are operated by closing or obstructing passageways which can direct or prevent the flow of fluids.

Valves have been used in the irrigation industry for years as a means to control the rate and volume of water that is used to soil a landscape. Irrigation is the ability to control the amount of water distributed to landscapes and crops at different intervals. Irrigation is an important feature of the agricultural industry and proper use of valves is needed to ensure the efficiency of the process.

There are several methods of irrigation which differ in how water is supplied. The goal concerning irrigation is to apply the water as evenly as possible so that each aspect of the land has an adequate amount of water needed for cultivation. Surface irrigation, often referred to as flood irrigation, moves water across the surface of agricultural lands in an effort to wet the soil and have the water penetrate the surface. Micro irrigation, often called localized irrigation, is a system where water is distributed under low pressure through a piped network. Drip irrigation is a system where water falls drop by drop at the root of plants.

In sprinkler or overhead irrigation, water is driven to a centralized location within a field and distributed by high-pressure sprinklers which may have a plurality of spray nozzles. Some valves have a bladder when filled with water. The pressure of incoming fluid will push the bladder to one side and close the valve. This method requires excessive amounts of time to close the valve. Many types of valves exist. Ball valves have on/off controls without a drop in pressure. Pinch valves regulate the flow of control. Diaphragm valves control flow by movement of an internal diaphragm. Choke valves raise or lower a solid cylinder around another cylinder. Valves vary in type and purpose such as safety valves, thermal expansion valves, butterfly valves, etc. Valves can by activated hydraulically, pneumatically, manually, or with a motor.

The speed of opening and closing valves is a problem in the industry. Many valves are connected to solenoids and can take up to a minute or two to close. The industry desires a solution to this lack of toggle speed.

### SUMMARY OF THE DISCLOSURE

The purpose of the Summary of Disclosure is to enable the public, and especially the scientists, engineers, and practitioners in the art who are not familiar with patent or legal terms or phraseology, to determine quickly from a cursory inspection, the nature and essence of the technical disclosure of the application. The Summary of the Disclosure is neither intended to define the invention of the application, which is measured by the claims, nor is it intended to be limiting as to the scope of the invention in any way.

To solve the problems noted in the background section, the present invention is an apparatus of a fast acting valve that can be turned off and on rapidly to control the exact amount of water to be applied. To do this, the valve controls the flow by toggling between an off/on state without using variable flow rates. Historically, the use of variable flow rates control water by restricting and enabling flow of water and or the volume of water.

In one embodiment, the fast acting valve applies a low current to an electromagnet and an electromagnetic disk which toggles the valve back and forth between a first position and a second position which actuates a rod and opens/closes a poppet. The fast-acting valve takes a low current because the valve does not need to overcome unnecessary forces such as pressure-holding and pocket-shuttering, which are present in other valves. The fast-acting valve must only overcome the friction of the diaphragms and low-friction guide. The fast-acting valve has a ferromagnetic disk that opens the valve and a biasing mechanism that closes the valve. To activate the ferromagnetic disk, a small electromagnetic force is applied to open the valve and when that force is no longer applied, the biasing mechanism closes the valve.

Disclosed is a control valve that directs the flow of a fluid. The control valve comprises a housing that has a first chamber and a second chamber. The first and second chamber are separated by a poppet and a seat. The first chamber has a diaphragm, and the second chamber has a second diaphragm. The diaphragms form a flexible barrier in their respective chambers. The first chamber has a first valve port and the second chamber has a second valve port.

The control valve has a rod which extends through the housing and is connected to a biasing mechanism on one end and a ferromagnetic disc on the other end. A mushroom drain sits between a shared wall of the first chamber and the second chamber.

The fluid control valve has a magnetic solenoid attached to the rod configured to receive current powered by a power supply. The magnetic solenoid is connected to the rod and able to move the rod from the first rod position to the second rod position.

The seat and poppet are attached to the rod and the poppet opens and closes when the rod is moved from the first rod position to the second rod position. The first chamber and second chamber have equal pressure when filled with fluid which allows the rod to move freely from the first rod position to the second rod position.

When the valve is configured for hydraulic power, the control valve has a hydraulic intake attached to the rod and is configured to receive power by an external hydraulic supply.

The seat is attached to the housing and the poppet is attached to the rod, whereas the seat and poppet separate from each other when the rod is moved from the first rod position to the second rod position. Since the first chamber and the second chamber have equal pressure when filled with fluid, the rod is allowed to move with little resistance and easily from the first rod position to the second rod position.

Still other features and advantages of the claimed invention will become readily apparent to those skilled in this art from the following detailed description of the preferred embodiments of the invention, simply by way of illustration of the best mode contemplated by carrying out the invention. As will be realized, the invention is capable of modification in various obvious respects all without departing from the invention. Accordingly, the description of the preferred embodiments are to be regarded as illustrative in nature, and not as restrictive in nature.

### BRIEF DESCRIPTION OF THE DRAWINGS

FIG. 1 is a top view of the inner workings of the valve with the electric option.

FIG. 2 is a top view of the inner workings of the valve with the hydraulic option.

FIG. 3 is a top view of the inner workings of the valve in a second position.

### DEFINITIONS

In the following description and in the figures, like elements are identified with like reference numerals.

The use of “e.g.,” and “or” indicates non-exclusive alternatives without limitation unless otherwise noted.

The use of “including” means “including, but not limited to,” unless otherwise noted.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

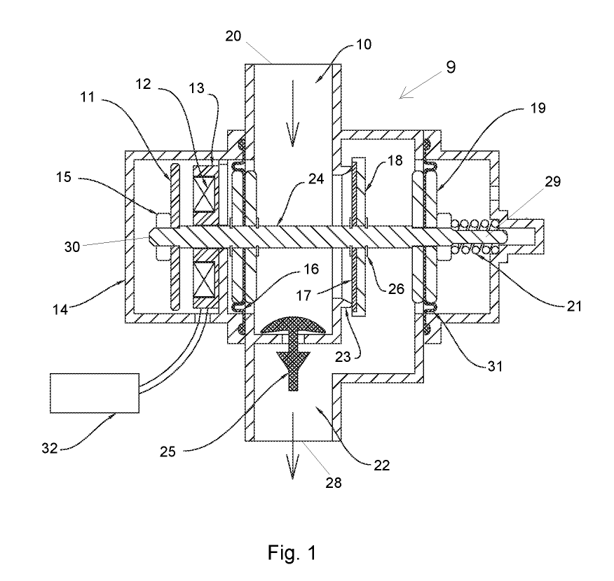

Certain preferred embodiments of the disclosed technology are shown in FIGS. 1 through 3.

Disclosed in FIG. 1 is a top view of the inner workings of the electromagnetic valve. Shown in the preferred embodiment is the housing 14 which comprises the first chamber 10 which provides an intake for fluid. When in the first position 33 the poppet 17 is closed to prevent fluid from entering the second chamber 22. In the closed position, the poppet 17 is attached to the poppet frame 18 which is attached to the rod 24. A fastening mechanism 15 is placed at the end of the rod 24 to secure it. In the preferred embodiment, the poppet 17 is forced against the poppet seat 23.

In the preferred embodiment, when the valve is in the second position 34, the poppet 17 is biased away from the poppet seat 23. This allows fluid to flow from the first chamber 10 into the second chamber 22 and then out of the valve 9. The rod 24 slides between the first position 33 and the second position 34 guided by the rod guide 26.

In the preferred embodiment, the valve with the electronic option is powered by an external power supply 32 which sends current to the coil 12 and magnetic solenoid 13. When charged, the ferromagnetic disk 11 is activated and biased to the coil 12 and magnetic solenoid 13 driving the rod 24 to the second position 34. Due to the use of electromagnetic power, the toggle from the first position 33 to the second position 34 is near instantaneous.

In the preferred embodiment, there is little resistance in the transition of the valve 9 from first position 33 to second position 34 when the first chamber 10 and the second chamber 22 are filled with fluid because the first chamber diaphragm 16 and second chamber diaphragm 31 will have equal pressure.

In the preferred embodiment, to toggle the rod 26 from the second position 34 to the first position 33, power to the ferromagnetic disk 11 is disengaged and the biasing mechanism 21 overcomes any resistance from the fluid quickly returning the rod 24 to the first position. A second disk is seated 19 on the rod 24 nearest the biasing mechanism 21. In the preferred embodiment, the biasing mechanism 21 is attached to the first rod end 29 and the ferromagnetic disk 11 and fastening mechanism 15 is connected to the second rod end 30.

In the preferred embodiment, fluid flows from the first valve port 20 in the first chamber 10 and fluid leaves the valve through the second valve port 28 in the second chamber 22.

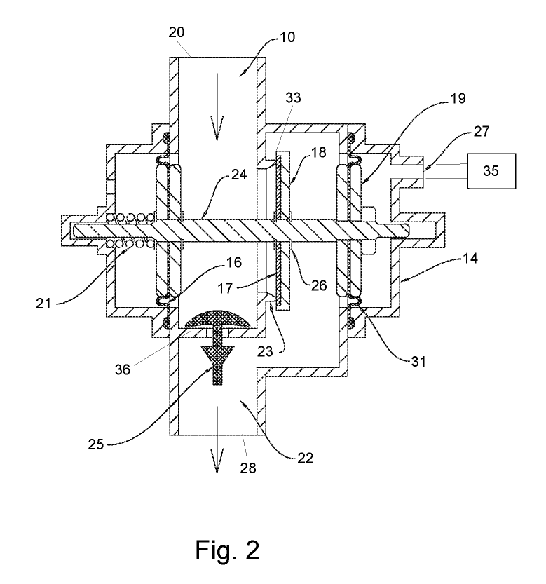

Disclosed in FIG. 2 is a top view of the inner workings of hydraulic valve. In the preferred embodiment, as shown, fluid comes in through the first chamber 10 and when the valve 9 is in the second position 34, fluid will fill the second chamber 22. The rod 24 moves back and forth between the first position 33 and the second position 34 along the rod guide 26. The rod is powered by hydraulic pressure that enters the valve 9 through the hydraulic intake 27. In the preferred embodiment, as shown, the biasing mechanism 21 will bias the poppet 17 against the poppet seat 23, which sits on the poppet frame 18.

In the preferred embodiment, a hydraulic supply 35 provides a hydraulic source that enters the valve 9 through the hydraulic intake 27.

In the preferred embodiment, the rod 24 will move along the rod guide 26 with little resistance when the first chamber 10 and the second chamber 22 are filled with fluid because the first chamber diaphragm 16 and the second chamber diaphragm 31 will have approximately the same amount of pressure.

In the preferred embodiment, the automatic drain 25 will drain the excess fluid when there is no fluid intake, electronic and and/or hydraulic force being applied. The automatic drain is seated on the first shared wall 36 which separates the first chamber 10 and the second chamber 22.

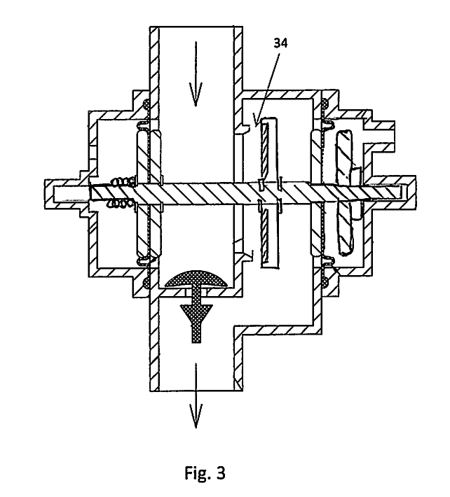

FIG. 3 is a top view of the inner workings of the valve in second position 34. In this position, fluid fills transfers from the first chamber 10 to the second chamber 22.

What is claimed is:

1. A control valve that directs the flow of a fluid, said control valve comprising:
a housing that has a first chamber and a second chamber, said first and second chamber further being separated by a poppet and a seat, with said first chamber comprising a first diaphragm, and said second chamber further comprising a second diaphragm, with said first diaphragm and said second diaphragm forming a flexible barrier, with said first chamber having a first valve port and said second chamber having a second valve port;
said control valve further comprising a rod extending through said housing, connected to a biasing mechanism on a first rod end, with a ferromagnetic disc connected to a second rod end;
said first chamber and said second chamber comprising a drain that seats between a first shared wall;
said control valve having a magnetic solenoid attached to said rod configured to receive current powered by a power supply, with said magnetic solenoid connected to said rod and able to move said rod from a first rod position to a second rod position in >0.1 seconds;
said biasing mechanism attached to said rod configured to toggle said rod from said second position to said first position in >0.1 seconds when magnetic solenoid is disengaged due to equal pressure applied to said diaphragms when valve is filled with fluid;
said seat is attached to said housing and said poppet is attached to said rod, whereas said poppet separates from said seat when said rod is moved from said first rod position to said second rod position; and
said first chamber and said second chamber having equal pressure when filled with said fluid, allowing rod to move freely from said first rod position to said second rod position in >0.1 seconds.

2. The control valve of claim 1, wherein said drain is a mushroom drain.

3. A control valve that directs the flow of a fluid, said control valve comprising:
a housing that has a first chamber and a second chamber, said first and second chamber further being separated by a poppet and a seat, with said first chamber comprising a first diaphragm, and said second chamber further comprising a second diaphragm, with said first diaphragm and said second diaphragm forming a flexible barrier, with said first chamber having a first valve port and said second chamber having a second valve port;
said control valve further comprising a rod extending through said housing, connected to a biasing mechanism on a first rod end;
said first chamber and said second chamber comprising a drain that seats between a first shared wall;
said control valve having a hydraulic intake attached to said rod configured to receive power by an external hydraulic supply, with said intake configured shift rod from a first rod position to a second rod position;
said seat is attached to said housing and said poppet is attached to said rod, whereas said poppet separates from said seat when said rod is moved from said first rod position to said second rod position;
said first chamber and said second chamber having equal pressure when filled with said fluid, allowing rod to move freely from said first rod position to said second rod position in >0.1 seconds; and
said biasing mechanism attached to said rod configured to toggle said rod from said second position to said first position in >0.1 seconds when magnetic solenoid is disengaged due to equal pressure applied to said diaphragms when valve is filled with fluid.

4. The control valve of claim 3, wherein said drain is a mushroom drain.
